(19) United States
(12) Patent Application Publication
(10) Pub. No.: US 2013/0087117 A1
(43) Pub. Date: Apr. 11, 2013

(54) HEAD ASSEMBLY AND VALVE-LESS INTERNAL COMBUSTION ENGINE

(71) Applicant: VAZTEC, LLC, Denver, NC (US)

(72) Inventors: Darrick Vaseleniuck, Denver, NC (US); David Vaseleniuck, Denver, NC (US)

(73) Assignee: VAZTEC, LLC, Denver, NC (US)

(21) Appl. No.: 13/647,921

(22) Filed: Oct. 9, 2012

Related U.S. Application Data
(60) Provisional application No. 61/545,342, filed on Oct. 10, 2011.

(51) Int. Cl. F02F 1/42; F02B 75/32

(52) U.S. Cl. 123/197.4; 123/193.5

(57) ABSTRACT

A head assembly and valve-less internal combustion engine are disclosed. The head assembly includes a head having a first port extending through the head and a surface defining a portion of a combustion chamber in fluid communication with the first port. The head further includes a first shaft mounted in a first bore of the head between the first port and the combustion chamber. The first shaft includes a first aperture extending therethrough and is rotatable between a first orientation wherein the first shaft blocks fluid communication between the first port and the combustion chamber and a second orientation wherein the first shaft permits fluid communication between the first port and the combustion chamber through the first aperture.

### BACKGROUND OF THE INVENTION

The present invention relates to internal combustion engines, and more particularly, the invention relates to a head assembly and valve-less internal combustion engine.

Internal combustion engines are well known and are used in various applications. For example, internal combustion engines are used in automobiles, farm equipment, lawn mowers, and watercraft. Internal combustion engines also come in various sizes and configurations, such as two stroke or four stroke and ignition or compression.

Typically, internal combustion engines (FIG. 1) include a multitude of moving parts, for example, they include intake and exhaust valves, rocker arms, springs, camshafts, connecting rods, pistons, and a crankshaft. One of the problems with having a multitude of moving parts is that the risk of failure increases (particularly in the valve train) and efficiency decreases due to frictional losses. Special lubricants and coatings may be used to reduce friction and certain alloys may be used to prevent failure; however, even with these enhancements, the risk of failure and the frictional losses remain high.

### BRIEF SUMMARY OF THE INVENTION

These and other shortcomings of the prior art are addressed by the present invention, which provides a valve-less internal combustion engine that increases reliability and increases efficiency.

According to one aspect of the invention, a head assembly for a valve-less internal combustion engine includes a head having a first port extending through the head and a surface defining a portion of a combustion chamber in fluid communication with the first port. The head further includes a first shaft mounted in a first bore of the head between the first port and the combustion chamber. The first shaft includes a first aperture extending therethrough and is rotatable between a first orientation wherein the first shaft blocks fluid communication between the first port and the combustion chamber and a second orientation wherein the first shaft permits fluid communication between the first port and the combustion chamber through the first aperture.

According to another aspect of the invention, a head assembly for a valve-less internal combustion engine includes a head and a first shaft mounted in a first bore of the head. The head includes a surface defining a portion of a combustion chamber, an intake port extending through the head and in fluid communication with the combustion chamber for directing combustion air into the combustion chamber, and an exhaust port extending through the head and in fluid communication with the combustion chamber for directing exhaust gas out of the combustion chamber. The first shaft is mounted between the combustion chamber and a selected one of the intake and exhaust ports. The first shaft includes a first aperture extending therethrough and is rotatable between a first orientation wherein the first shaft blocks fluid communication between the combustion chamber and the selected one of the intake and exhaust ports and a second orientation wherein the first shaft permits fluid communication between the combustion chamber and the selected one of the intake and exhaust ports through the first aperture.

According to another aspect of the invention, a valve-less internal combustion engine includes an engine block containing a rotating assembly and a head assembly. The rotating assembly includes a crankshaft positioned for rotation in the engine block, a piston adapted for linear movement in a cylinder between a first, non-compression position and a second, compression position, and a connecting rod for interconnecting the crankshaft and the piston such that rotation of the crankshaft causes the connecting rod to move the piston between the first and second positions. The head assembly includes a head having a first port extending through the head and in fluid communication with a combustion chamber defined by the cylinder and the head collectively. The head assembly further includes a first shaft mounted in a first bore of the head between the first port and the combustion chamber. The first shaft includes a first aperture extending therethrough and is rotatable between a first orientation wherein the first shaft blocks fluid communication between the first port and the combustion chamber and a second orientation wherein the first shaft permits fluid communication between the first port and the combustion chamber through the first aperture.

### BRIEF DESCRIPTION OF THE DRAWINGS

The subject matter that is regarded as the invention may be best understood by reference to the following description taken in conjunction with the accompanying drawing figures in which:

FIG. 1 shows a prior art V-8 internal combustion engine; and

FIG. 2 shows an internal combustion engine according to an embodiment of the invention;

FIG. 3 shows a head assembly of the internal combustion engine of FIG. 2;

FIGS. 4A-4D show the four strokes of the internal combustion engine of FIG. 2;

FIG. 5 shows an internal combustion engine according to an embodiment of the invention;

FIGS. 6-7 show a head assembly of the internal combustion engine of FIG. 5;

FIG. 8 shows an intake and exhaust shaft of the internal combustion engine of FIG. 5; and

FIGS. 9A-9D show the four strokes of the internal combustion engine of FIG. 5.

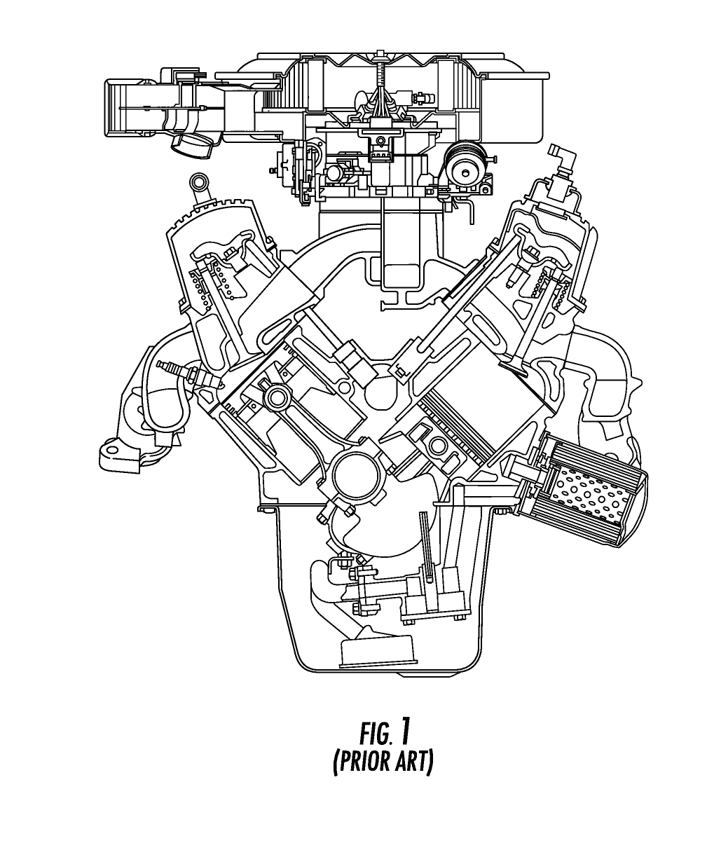

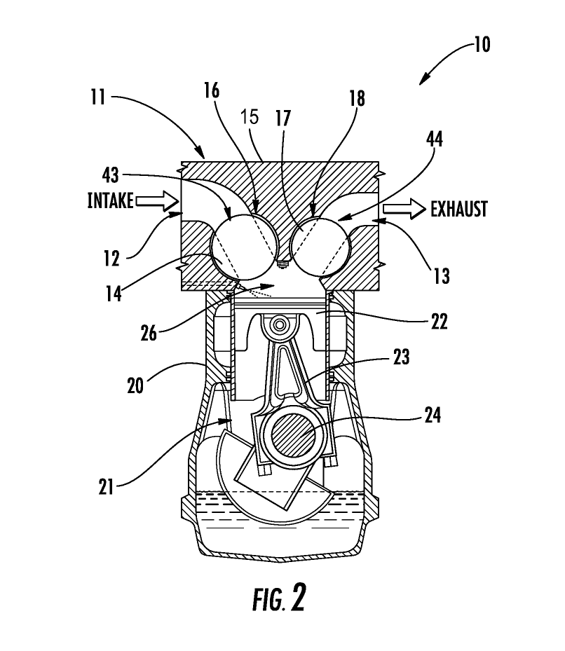

### DETAILED DESCRIPTION OF THE INVENTION

Referring to the drawings, an exemplary valve-less internal combustion (IC) engine according to an embodiment is shown generally at reference numeral 10. The engine 10 includes a head assembly 11 having head 15 with at least one intake port 12, at least one exhaust port 13, a rotatable intake shaft 14 secured in a first bore 16 of the head 15, and a rotatable exhaust shaft 17 secured in a second bore 18 of the head assembly 15. The head assembly 11 may be part of or mounted on a standard engine block 20 having a rotating assembly 21 (piston 22, connecting rod 23, and crankshaft 24) contained therein. As shown, the rotating intake shaft 14 and rotating exhaust shaft 17 are positioned between the at least one intake port 12 and at least one exhaust port 13, respectively, and a combustion chamber 26. It should be appreciated that at least a portion of the combustion chamber 26 is defined by a surface of the head It should be appreciated that the number of head assemblies 11 on an engine will depend on the number of cylinders the engine has. A single cylinder engine is simply being used for discussion purposes. It should also be appreciated that the head assembly may be a single head design or of a two-part head design.

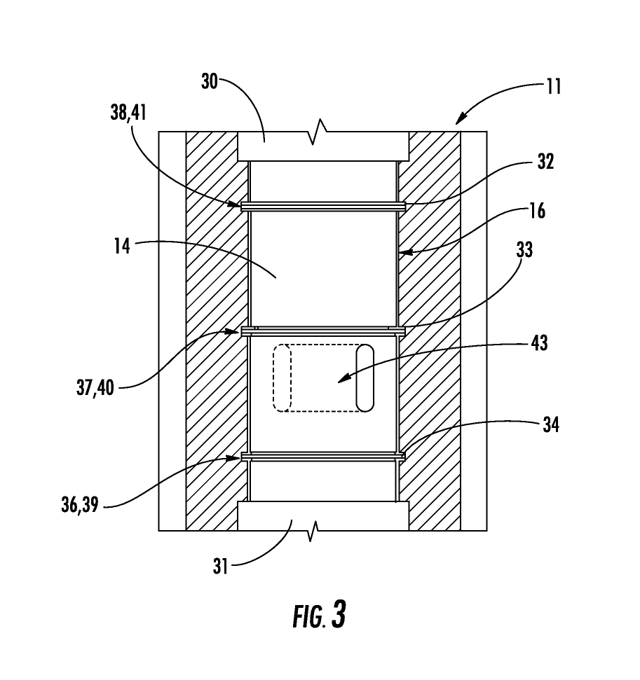

For purposes of the following discussion, since the intake and exhaust shaft assemblies are the same, only the intake shaft 14 will be discussed. As illustrated in FIG. 3, the intake shaft 14 resides in the first bore 16 of the head 15 and is rotatably mounted in the bore 16 by bearings 30 and 31. Seals 32-34 are positioned within grooves 36-38 of the bore 16 and grooves 39-41 of the intake shaft 14 to prevent gas leakage. The intake shaft 14 has a pre-determined diameter and includes an aperture 43 having a pre-determined diameter that extends through the shaft 14 to allow intake air to move through the intake port 12, through the aperture 43, and into the combustion chamber 26. It should be appreciated that the shaft 14 may have multiple smaller apertures or a single large aperture, as shown. It should also be appreciated that the size of the aperture 43 is dependent on the shaft diameter and the desired timing. By changing the diameter of the aperture 43, the timing of the engine may be changed.

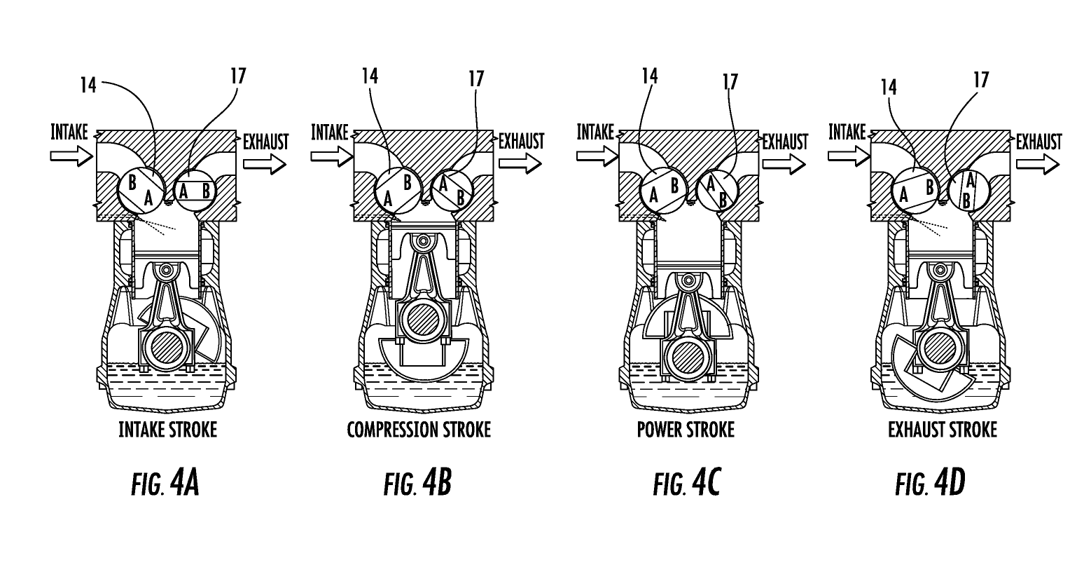

Referring to FIG. 4, the intake shaft 14 and exhaust shaft 17 are driven by a belt or chain (not shown) attached to the crankshaft 24 and rotate at a 4 to 1 ratio relative to the crankshaft 24. During the four strokes of an engine, the intake shaft 14 and exhaust shaft 17 constantly rotate to position their apertures in the proper position relative to the ports 12, 13. The “A” and “B” notations in the apertures 43 and 44 are used to show the rotation of the shafts 14 and 17 relative to the strokes. As shown, during the intake stroke, the aperture 43 of the intake shaft 14 is substantially aligned with the intake port 12 to allow air into the combustion chamber 26. Aperture 44 of the exhaust shaft 17 is positioned such that exhaust shaft 17 closes the exhaust port 13 and air or gas is prevented from escaping the combustion chamber 26 through the exhaust port 13. During the compression stroke, the apertures 43 and 44 of the intake and exhaust shafts 14 and 17 are both rotated to close off the intake port 12 and exhaust port 13. During the power stroke, the apertures 43 and 44 of the intake and exhaust shafts 14 and 17 continue to keep the intake and exhaust ports 12, 13 closed. Finally, during the exhaust stroke, the intake shaft 14 continues to close the port 12 and exhaust shaft 17 is positioned such that the exhaust port 13 is now opened by substantially aligning the aperture 44 with the exhaust port 13. The process then repeats. During this process, an overlapping occurs, i.e., as the exhaust port begins to close, the intake begins to open to complete the overlap which begins the charge (air runs into the combustion chamber). It should be appreciated that in a dual shaft system like being described, the separation of the apertures 43 and 44 may be adjusted to change the timing of the engine.

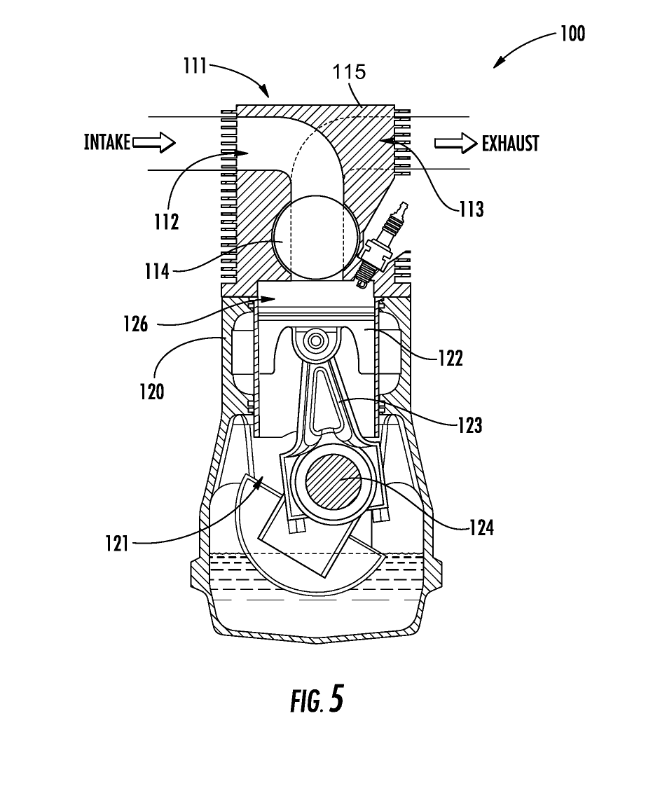

Referring now to FIG. 5, a valve-less internal combustion (IC) engine according to an embodiment is shown generally at reference numeral 100. Like engine 10, engine 100 includes a head assembly 111 having a head 115 with an intake port 112 and an exhaust port 113. The head assembly 111 may be part of or mounted to a standard engine block 120 having a rotating assembly assembly 121 (piston 122, connecting rod 123, and crankshaft 124) contained therein. The main difference between the engine 10 and 100 is that the engine 100 uses a single rotating shaft 114 to perform both intake and exhaust processes.

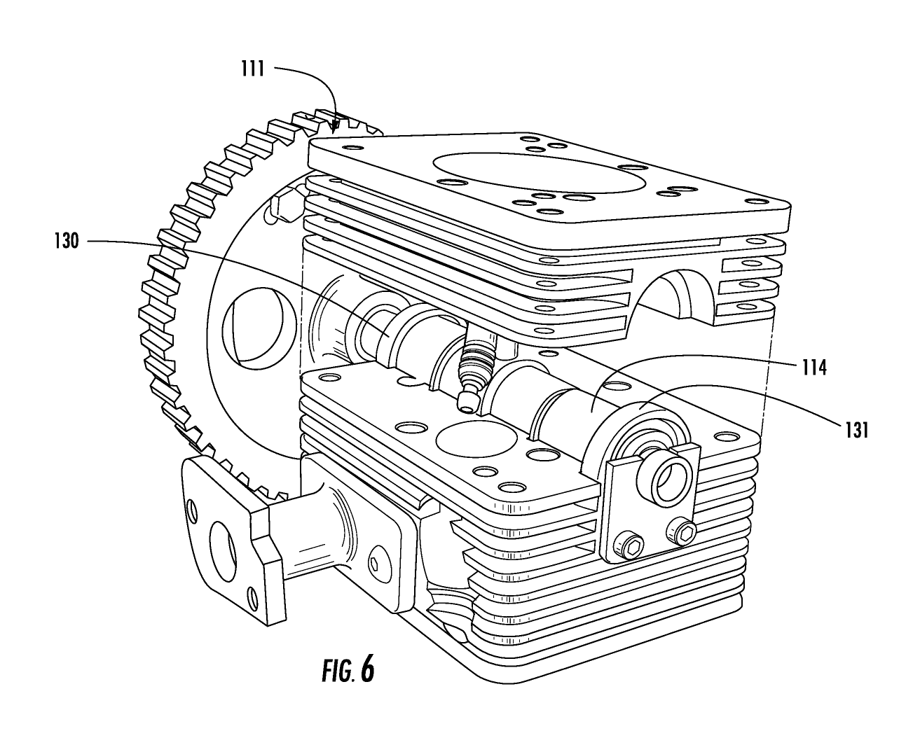

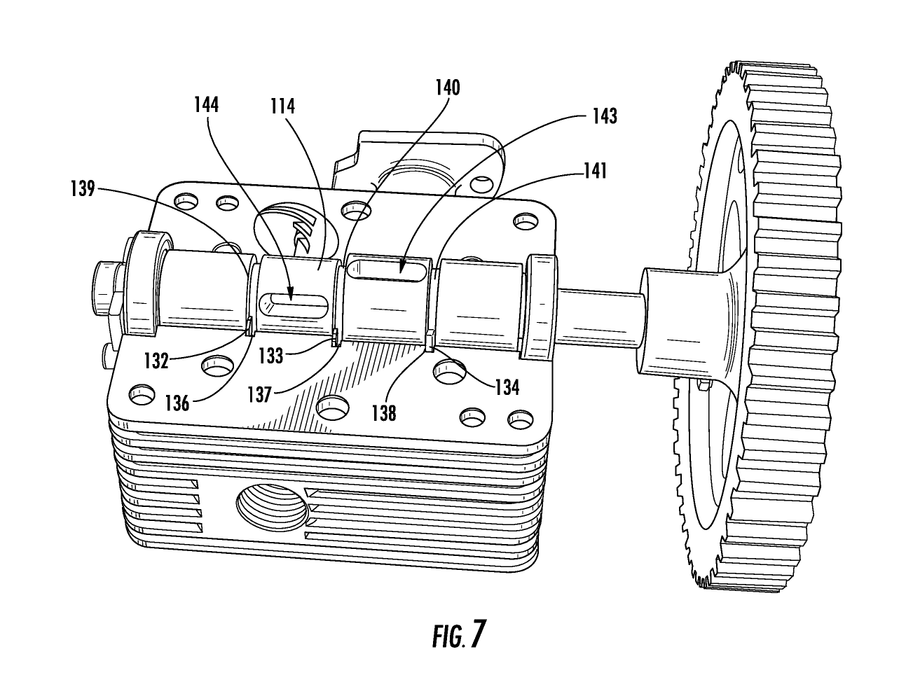

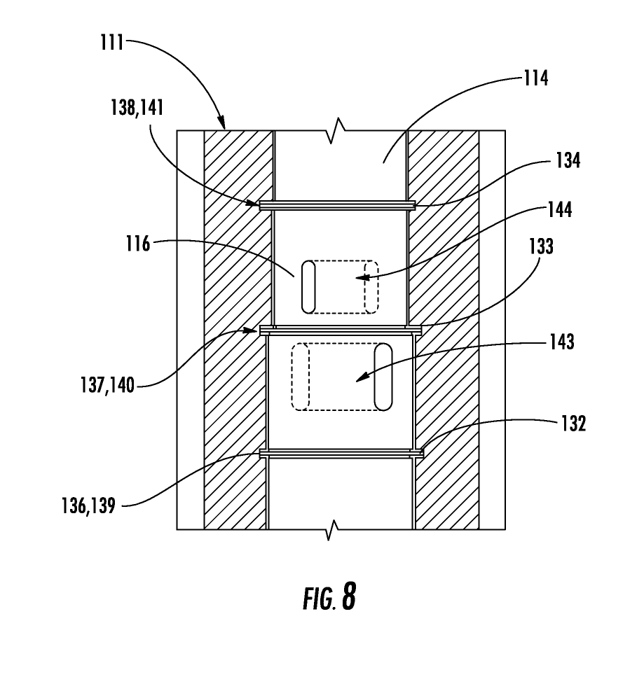

Referring to FIGS. 6-8, as discussed above with respect to head assembly 11, the rotating shaft 114 resides in a bore 116 of the head 115 and is rotatably mounted in the bore 116 by bearings 130 and 131. Seals 132-134 are positioned within grooves 136-138 of the bore 116 and grooves 139-141 of the shaft 114 to prevent gas leakage. The shaft 114 has a pre-determined stepped diameter design and includes an intake aperture 143 having a pre-determined diameter and an exhaust aperture 144 having a pre-determined diameter. The intake aperture 143 extends through the shaft 114 to allow intake air to move through the intake port 112, through the aperture 143, and into combustion chamber 126. The exhaust aperture 144 is positioned on a smaller diameter section of the shaft 114 and at a pre-determined angle relative to the intake aperture 143 to provide a separation therebetween. The exhaust aperture 144 extends through the shaft 114 to allow exhaust air or gas to move out of the combustion chamber 126, through the exhaust aperture 144, and out the exhaust port 113. It should be appreciated that the shaft 114 may have multiple smaller apertures or a single large aperture, as shown, for each of the intake and exhaust apertures 143, 144. It should also be appreciated that the size of the apertures 143 and 144 are dependent on the shaft diameter and the desired timing. By changing the diameter of the apertures 143 and 144, the timing of the engine may be changed. It should be appreciated that the shaft 114 may be driven by a belt or chain via the crankshaft as described above with respect to engine 10.

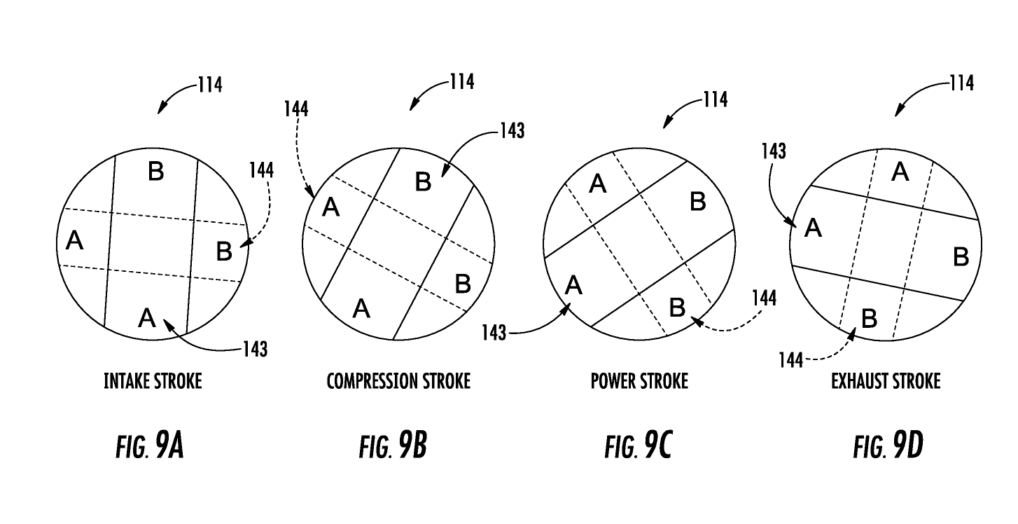

As illustrated in FIG. 9, the intake and exhaust apertures 143 and 144 are separated to allow a four stroke engine to function properly. During the four strokes of the engine 100, the shaft 114 constantly rotates to position the apertures 143, 144 in the proper position relative to the ports 112, 113. As shown, during the intake stroke, the aperture 143 is substantially aligned with the intake port 112 to allow air into the combustion chamber 126. Aperture 144 is positioned such that shaft 114 closes the exhaust port 113 and air or gas is prevented from escaping the combustion chamber 126 through the exhaust port 113. During the compression stroke, the apertures 143 and 144 are both rotated to close off the intake port 112 and exhaust port 113. During the power stroke, the apertures 143 and 144 continue to keep the intake and exhaust ports 112, 113 closed. Finally, during the exhaust stroke, the shaft 114 continues to close the port 112 and aperture 144 substantially aligns with the port 113 to open the exhaust port 113 and allow gas to escape the combustion chamber 126. The process then repeats. During this process, an overlapping occurs, i.e., as the exhaust port begins to close, the intake begins to open to complete the overlap which begins the charge (air runs into the combustion chamber).

The foregoing has described a valve-less internal combustion engine. While specific embodiments of the present invention have been described, it will be apparent to those skilled in the art that various modifications thereto can be made without departing from the spirit and scope of the invention. Accordingly, the foregoing description of the preferred embodiment of the invention and the best mode for practicing the invention are provided for the purpose of illustration only and not for the purpose of limitation.

We claim:

1. A head assembly for a valve-less internal combustion engine, comprising:
(a) a head including:
(i) a first port extending through the head;
(ii) a surface defining a portion of a combustion chamber in fluid communication with the first port;
(b) a first shaft mounted in a first bore of the head between the first port and the combustion chamber, wherein the first shaft includes a first aperture extending therethrough, the first shaft being rotatable between a first orientation wherein the first shaft blocks fluid communication between the first port and the combustion chamber and a second orientation wherein the first shaft permits fluid communication between the first port and the combustion chamber through the first aperture.

2. The head assembly according to claim 1, wherein the head includes a second port extending through the head and in fluid communication with combustion chamber.

3. The head assembly according to claim 2, further including a second shaft mounted in a second bore of the head between the second port and the combustion chamber, wherein the second shaft includes a second aperture extending therethrough, the second shaft being rotatable between a first orientation wherein the second shaft blocks fluid communication between the second port and the combustion chamber and a second orientation wherein the second shaft permits fluid communication between the second port and the combustion chamber through the second aperture.

4. The head assembly according to claim 2, wherein the first shaft includes a second aperture extending therethrough, the first shaft being rotatable between a third orientation wherein the first shaft blocks fluid communication between the second port and the combustion chamber and a fourth orientation wherein the first shaft permits fluid communication between the second port and the combustion chamber through the second aperture.

5. A head assembly for a valve-less internal combustion engine, comprising:
(a) a head including:
(i) a surface defining a portion of a combustion chamber;
(ii) an intake port extending through the head and in fluid communication with the combustion chamber for directing combustion air into the combustion chamber;
(iii) an exhaust port extending through the head and in fluid communication with the combustion chamber for directing exhaust gas out of the combustion chamber;
(b) a first shaft mounted in a first bore of the head between the combustion chamber and a selected one of the intake and exhaust ports, wherein the first shaft includes a first aperture extending therethrough, the first shaft being rotatable between a first orientation wherein the first shaft blocks fluid communication between the combustion chamber and the selected one of the intake and exhaust ports and a second orientation wherein the first shaft permits fluid communication between the combustion chamber and the selected one of the intake and exhaust ports through the first aperture.

6. The head assembly according to claim 5, wherein the first shaft is mounted between the intake port and the combustion chamber.

7. The head assembly according to claim 6, further including a second shaft mounted in a second bore of the head between the exhaust port and the combustion chamber, wherein the second shaft includes a second aperture extending therethrough, the second shaft being rotatable between a first orientation wherein the second shaft blocks fluid communication between the combustion chamber and the exhaust port and a second orientation wherein the second shaft permits fluid communication between the combustion chamber and the exhaust port through the second aperture.

8. The head assembly according to claim 5, wherein the first shaft is mounted between the exhaust port and the combustion chamber.

9. The head assembly according to claim 8, further including a second shaft mounted in a second bore of the head between the intake port and the combustion chamber, wherein the second shaft includes a second aperture extending therethrough, the second shaft being rotatable between a first orientation wherein the second shaft blocks fluid communication between the combustion chamber and the intake port and a second orientation wherein the second shaft permits fluid communication between the combustion chamber and the intake port through the second aperture.

10. The head assembly according to claim 5, wherein the first shaft is mounted between the combustion chamber and both the intake and exhaust ports.

11. The head assembly according to claim 10, wherein the first shaft includes a second aperture extending therethrough, wherein the first aperture is in fluid communication with the intake port and the second aperture is in fluid communication with the exhaust port such that when the first shaft is in the first orientation, the first shaft blocks fluid communication between the intake port and the combustion chamber and when the first shaft is in the second orientation, the first shaft permits fluid communication between the combustion chamber and the intake port through the first aperture, and wherein when the first shaft rotates to a third orientation, the second aperture blocks fluid communication between the combustion chamber and the exhaust port and when the first shaft rotates to a fourth position, the shaft permits fluid communication between the combustion chamber and the exhaust port through the second aperture.

12. A valve-less internal combustion engine, comprising:
(a) an engine block containing a rotating assembly, the rotating assembly having:
(i) a crankshaft positioned for rotation in the engine block;
(ii) a piston adapted for linear movement in a cylinder between a first, non-compression position and a second, compression position; and
(iii) a connecting rod for interconnecting the crankshaft and the piston such that rotation of the crankshaft causes the connecting rod to move the piston between the first and second positions;
(b) a head assembly having:
(i) a head, the head including a first port extending through the head and in fluid communication with a combustion chamber, wherein the combustion chamber is defined by the cylinder and the head collectively;
(ii) a first shaft mounted in a first bore of the head between the first port and the combustion chamber, wherein the first shaft includes a first aperture extending therethrough, the first shaft being rotatable between a first orientation wherein the first shaft blocks fluid communication between the first port and the combustion chamber and a second orientation wherein the first shaft permits fluid communication between the first port and the combustion chamber through the first aperture.

13. The valve-less internal combustion engine according to claim 12, wherein the head includes a second port extending through the head and in fluid communication with combustion chamber.

14. The valve-less internal combustion engine according to claim 13, further including a second shaft mounted in a second bore of the head between the second port and the combustion chamber, wherein the second shaft includes a second aperture extending therethrough, the second shaft being rotatable between a first orientation wherein the second shaft blocks fluid communication between the second port and the combustion chamber and a second orientation wherein the second shaft permits fluid communication between the second port and the combustion chamber through the second aperture.

15. The valve-less internal combustion engine according to claim 13, wherein the first shaft includes a second aperture extending therethrough, the first shaft being rotatable between a third orientation wherein the first shaft blocks fluid communication between the second port and the combustion chamber and a fourth orientation wherein the first shaft permits fluid communication between the second port and the combustion chamber through the second aperture.

16. The valve-less internal combustion engine according to claim 12, wherein the first shaft is connected to the crankshaft such that rotation of the crankshaft causes the first shaft to rotate.

17. The valve-less internal combustion engine according to claim 16, wherein the first shaft rotates at a four-to-one ratio relative to the crankshaft.

18. The valve-less internal combustion engine according to claim 14, wherein the second shaft is connected to the crankshaft such that rotation of the crankshaft causes the second shaft to rotate.

19. The valve-less internal combustion engine according to claim 18, wherein the second shaft rotates at a four-to-one ratio relative to the crankshaft.

20. The valve-less internal combustion engine according to claim 15, wherein the first aperture and second aperture are positioned along a length of the first shaft in a spaced-apart, offset relation.
